(19) United States
(12) Patent Application Publication
(10) Pub. No.: US 2003/0132961 A1
(43) Pub. Date: Jul. 17, 2003

(54) Accessing functionalities in hypermedia

(76) Inventors: Robert Aarts, Espoo (FI); Peter Dam Nielsen, Bronshoj (DK); Franklin Davis, Newton, MA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/024,717

(22) Filed: Dec. 21, 2001

(51) Int. Cl. G09G 5/00

(52) U.S. Cl. 345/760

(57) ABSTRACT

A browser parses an XHTML document to identify links in the document that are marked up with the accesskey attribute and forms an options list containing the links, so that they can be selected independently of their position in the document.

### FIELD OF THE INVENTION

This invention relates to accessing functionalities in hypermedia and has particular but not exclusive application to displaying links independently of their location within a hypertext document.

### BACKGROUND OF THE INVENTION

Recommendations have been developed to provide a wireless application protocol (WAP) to promote common standards and specifications for data services that operate over wireless communication networks. For example, mobile devices such as telephone handsets can be WAP enabled to allow a user to access remote servers. Other mobile data communication services have also been developed such as I-mode. Data content is provided in a mark up language, similar to conventional hypertext mark up language (HTML), known as wireless mark up language (WML). This is configured to allow data to be displayed as a deck of individual cards which are of the size suited for display on the relatively small display screen usually available on a mobile device such as a mobile telephone handset or personal digital assistant (PDA).

The mobile device runs a browser to display data from the server and the user controls navigation between different decks and cards with keys on the mobile device. Typically, the mobile device has a smaller number of keys than a conventional personal computer and does not have a mouse, and so navigating with the browser of the mobile device gives rise to a problem in terms of ergonomics, in relation to the ease of browser controllability for the user. For example, the deck of cards may include a number of different links to different network locations, each specified by individual universal resource locator (URL). The user may have difficulty in identifying the URLs provided in a particular deck of cards and so, hitherto, the browser has been configured to provide a list of such links separately from the display of the individual cards so that the user can operate an “option” key to select the list of links. This has the advantage that the user does not need to browse through the entire deck of cards to determine the links available. In the past, the provision of the options list has been achieved using the “DO” element. This is a conventional feature of WML, which as explained in more detail hereinafter, causes the user interface to perform predetermined user controlled functions. For a full description of the DO element, reference is directed to “Official Wireless Application Protocol” Wireless Application Protocol Forum Limited, Wiley, 1999 (ISBN0-471-32755-7) pp 87-89. In order to provide the options list, links that are marked with a DO element are provided in the options list. Then, having selected the list, the user can select an individual link from the list. Thus, the user does not need to browse through the entire deck of cards to identify the links contained within it.

Recently, it has been proposed to provide browsers compatible with XHTML rather than WML. XHTML is a development of HTML 4, and is described in XHTML 1.0: The Extensible Hypertext Mark Up Language (second edition)—a reformulation of HTML 4 in XML 1.0, W3C working draft Oct. 4, 2001 published by W3C. XHTML is suitable for use with alternative platforms to those conventionally used for HTML, such as fixed work stations and personal computers. XHTML differs from WML in that the content is not arranged in a deck of cards but rather in documents more akin to conventional HTML for use with conventional browsers on personal computers. Many of the elements of XHTML are similar to those of HTML. However, neither XHTML nor HTML include the DO element found in WML and so it is not possible to provide the previously described options list that can be achieved in WML, for a XHTML browser.

It is an object of the invention to overcome this problem.

### SUMMARY OF THE INVENTION

According to the invention there is provided a method of accessing functionalities in hypermedia to be parsed and rendered by a user agent, the hypermedia including at least one element that has a predetermined attribute whereby a dynamically assignable keyboard shortcut for the user agent actuates a predetermined functionality associated with the element, the method comprising: parsing the hypermedia collating data corresponding to those elements in the hypermedia that support said predetermined attribute, and rendering a display of the collated data.

The invention also includes a browser for hypermedia marked up with at least one element that has a predetermined attribute whereby the actuation by a user of a selected individual keyboard control, actuates a predetermined functionality associated with the element, the browser including software to provide: a parsing process to parse the hypermedia a process to identify data corresponding to those elements in the hypermedia that support said predetermined attribute, and a process to render a display of the data.

The predetermined attribute may be an accesskey function. The browser may be configured for use with XHTML.

The browser may be provided in a mobile device such as a mobile telephone handset or a PDA.

The invention has the advantage of providing a list of elements independently of the hypermedia containing them, by the use of an attribute such as an accesskey.

The invention also includes a device for rendering hypermedia received from a remote server, the device including a processor for the hypermedia and a user interface including a display device and a keyboard with a plurality of keys operable in a first mode to enter associated alphanumeric data, and operable in a second mode to actuate respective keyboard shortcuts dynamically assigned thereto by elements in the hypermedia, the processor and the display device being operable in a first display configuration to display the hypermedia, the processor being operable to identify elements that define predetermined keyboard shortcuts in the hypermedia, and form an options list containing data associated with the identified elements, and the processor and the display device being operable in a second display configuration to display the options list.

### BRIEF DESCRIPTION OF THE DRAWINGS

In order that the invention may be more fully understood, an embodiment will now be described with reference to the accompanying drawings in which;

FIG. 1 is a schematic block diagram illustrating a mobile telephone handset that can communicate through a PLMN to a server;

FIG. 2 is a schematic block diagram of a the circuitry of the mobile handset shown in FIG. 1;

FIG. 3 illustrates schematically that the display of the handset and the associated keys 4;

FIG. 4 illustrates a scrolling functionality associated with key 4c;

FIG. 5 is a schematic illustration of the process performed by the browser;

FIG. 6A and 6B illustrate screen displays for the mobile telephone handset when using either a prior WML browser, or a XHTML browser in accordance with the invention;

FIG. 7 is a schematic flow diagram of the process steps carried out when parsing an XHTML document in accordance with the invention;

FIG. 8 is a screen display for a second example of the invention;

FIG. 9 is a schematic illustration of an XHTML document; and

FIG. 10 is a schematic illustration of the options list provided in accordance with the invention for the XHTML document shown in FIG. 9.

### DETAILED DESCRIPTION

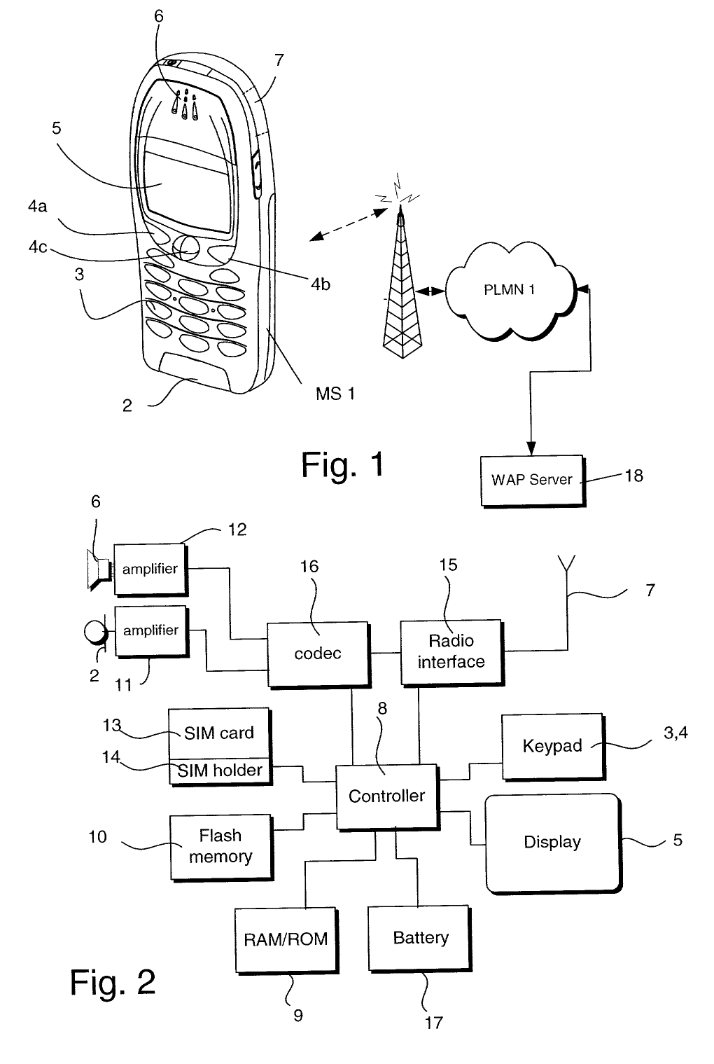

In FIG. 1, a mobile station in the form of a battery driven telephone cellular handset MS 1, is shown schematically in radio communication with PLMN 1. The mobile handset MS1, includes a microphone 2, keypad 3, soft keys 4, a liquid crystal display device 5, ear-piece 6 and internal antenna 7. As will be explained in more detail, the handset 1 is enabled with a user agent in the form of a browser for browsing hypermedia.

The circuitry of the handset MS 1 is shown in more detail in FIG. 2. Signal processing is carried out under the control of a digital micro-controller 8 that has an associated RAM/ROM 9 and flash memory 10. Electrical analogue audio signals are produced by microphone 2 and amplified by pre-amplifier 11. Similarly, analogue audio signals are fed to the earpiece 6 through an amplifier 12. The micro-controller receives instruction signals from the keypad and so-called soft keys 4 and controls operation of the LCD display 5.

Information concerning the identity of the user is held on a smart card 13 in the form of a GSM SIM card, which contains the usual GSM international mobile subscriber identity and encryption K₁ that is used for encoding the radio transmission in a manner well known per se. The SIM card 13 is removably received in a SIM cardholder 14. Radio signals are transmitted and received by means of the antenna 7 connected through a rf stage 15 to a codec 16 configured to process signals under the control of a micro-controller 8. Thus, in use, for speech, the codec 16 receives analogue signals from the microphone amplifier 11, digitises them into a form suitable for transmission and feeds them to the rf stage 15 for transmission through antenna element 7 to PLMN 1 shown in FIG. 1. Similarly, signals received from PLMN 1 are fed through the antenna element to be demodulated by the rf stage 15 and fed to codec 16 so as to produce analogue signals fed to amplifier 12 and earpiece 6.

The handset 1 is enabled to receive and display hypermedia in a browser. Data can be downloaded to the browser from a server 18 shown in FIG. 1. The server 18 provides hypermedia in the form of pages that can be downloaded to the handset MS1 and manipulated for display by means of the keys 3, 4. The server 18 may be accessed through a gateway (not shown), which acts as a proxy server. The handset MS 1 can access the gateway by dialling a predetermined telephone number.

The hypermedia downloaded from the server 18 may be held in the RAM 9 or the flash memory 10. The microcontroller 8 provides the browser functionality and causes pages to be presented to the user in the browser on the screen of the display 5, and the display can be manipulated by means of the keys 3,4.

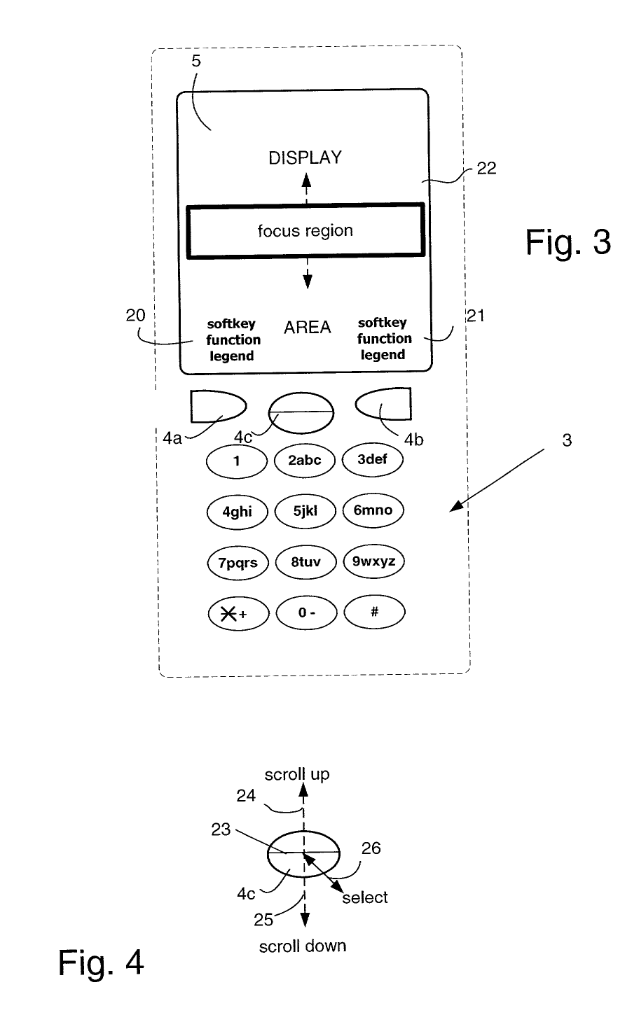

The functionality of the soft keys 4 will now be described in more detail with reference to FIG. 3. The keys 4 are disposed adjacent the underside of the display 5. The keys 4a, 4b comprise manually depressible buttons. Their functionality can be pre-programmed depending upon the task performed. The function attributed to the keys is displayed on the display 5 as soft key function legends 20, 21 adjacent to the respective keys 4a, 4b.

The key 4c comprises a roller device to perform a scrolling function for the display 5. In use, an active or focus region 22 is provided on the display which, as explained in more detail later, can be moved around the display area. The roller 4c may comprise a 3-way roller, as shown in FIG. 4. The roller may be pushed by the user's finger, to pivot about axis 23. When pushed upwardly, in the direction of arrow 24, a “scroll-up” function is performed. Conversely, when pushed downwardly in the direction of arrow 25 a “scroll-down” function is performed. Additionally, the roller 4c may be manually depressible inwardly of the handset, in the direction of arrow 26, to perform a “select” function. The key 4c may be further configured as a five-way roller, not shown, so as additionally to perform right and left scrolling functions. Alternatively, the key 4c may comprise a rollerball, a touch pad or other navigation device of the type used in laptop computers. In this example, the focus region 22 is delineated by a rectangular box which is moved around the screen of the display 5. However, the focus region can be provided in different ways, such as a region highlighted with a different intensity or colour from the rest of the display, an underlining of a menu option or by means of a pointer movable across the display in the manner of a conventional mouse pointer.

It is known in the art that the handset 1 may be WAP enabled and capable of receiving data in a predetermined channel. For example, in GSM, a data channel is available at 9.6 kbit/sec. Also, the handset may be configured to receive high speed circuits switch data (HSCSD) according to the GSM recommendations. It would also be possible to use GPRS and formats appropriate to 3G, or other data transmission techniques such as I-mode. The WAP content and its applications are specified in a well known set of content formats based upon familiar www content formats. WAP is disclosed in the wireless application protocol architecture Specification; Version 1.3, published by The Wireless Application Protocol Architecture Working Group, Feb. 19, 2000.

The browser operated by the handset 1, may comprise a micro-browser that acts as a client in the WAP environment for connection to WAP servers.

WML

Conventionally, the browser is configured for use with WML, which comprises a lightweight mark-up language similar to HTML but optimised for handheld mobile terminals. This will now be described in more detail to explain the problem solved by the invention.

In order to accommodate the relatively small display areas provided in mobile devices, a conventional page of HTML is broken down into smaller units known as cards, arranged in a deck.

The deck commences with a prologue and is delimited by a <wml> tag. An example of the syntax of a deck of two cards is set out below.

WML Code Snippet No.1

```
<wml>
  <head>
  <template>
  <card>
  <do type=“accept”>
    <go url= “#card2”/>
    </do>
    Hello World!
    This is the first card...........
  </card>
  <card name= “card2”>
    This is the second card.
    Goodbye.
  </card>
</wml>
```

Elements and attributes of WML code will now be explained with reference to the example.

Head Element

The <head> element contains optional information about the deck as a whole, including access control information to control access to the deck so that only permitted links may gain access.

Template Element

The <template> element contains optional information about deck-level bindings.

Card Element

The <card> element defines the user interface and processing logic of the deck. As previously mentioned, the deck may include a number of cards and in this example, two cards are included.

DO Element

The DO element provides a general mechanism for the user to act upon the current card, and is mapped onto a particular user operated control such as a key of the keypad. In this example, the operation of the soft key 4c in the direction of arrow 26, actuates the DO element. In more detail, this operation the key 4c corresponds to “accept” in the WML code listed above, so that when the user actuates key 4c as described, whilst the first card is being displayed on the display screen 5, the user has for the purposes of the WML code, typed “accept”, which triggers the DO element. In this example, the DO element triggers a GO element that goes to the universal resource locator (url) of the second card of the deck, and causes the second card to be displayed. The DO element can be included at the card level or can be included in the template to operate on all cards in the deck.

ANCHOR Element

As with HTML, links can be defined. In WML, the links can be between decks or cards. The links are defined in WML by an ANCHOR element that defines the head of the link. WML also includes an element A, which is a shorthand version of the ANCHOR element. This is not shown in WML code snippet No.1 above, but will be explained in more detail later.

INPUT Element

Furthermore, WML allows a user to insert text, for example to enter a user name, by means of an element INPUT. This element thus specifies a text entry object, in a similar manner to HTML.

Accesskey Attribute

As in HTML, certain WML elements have an attribute that assigns an access key to the element. In this way, the WML elements can be given a particular focus by operating a predetermined key on the keyboard 3,4 of the device. The attribute is defined in WML as accesskey and is an attribute of the WML elements: ANCHOR, A and INPUT.

An example is given below of the use of the accesskey element in a link using the A element (with A being shown in lower case i.e. “a” below):

<a accesskey=“1”

href=http://someplace.com/specification/contents.html>Table of Contents</a>

The accesskey functionality may be invoked by actuating the key concerned for a longer time than usual. Thus, in this example, when the key “1” on the keypad is pressed for a short period, it enters a “1”, but if a long key-press is used, the accesskey functionality is invoked and a link to the domain “someplace” is actuated, to locate the contents of a table.

A more detailed description of these WML elements and others is given in “Official Wireless Application Protocol” Wiley, 1999 [ISBN 0-471-32755-7]

As previously mentioned, the small size of the display 5 used in portable devices means that only part of the deck can be displayed at any time so that links contained within the deck are not necessarily visible whilst the user browses the content of the deck. Hitherto, WML browsers have been configured so that one of the soft keys 4a, 4b is configured to offer the user an options list, in which links associated with a DO element are listed in a separate options screen so that all relevant links can be reviewed by the user without having to browse through the entire deck of cards. WML code snippet number 2 given below illustrates an example of how the DO element can be used in this way.

WML Code Snippet No.2

```
<WML>
  <CARD NAME=“Cnnnews” TITLE=“CNN News”>
  <A>Domestic news<GO URL=“domnews.wml”/></A>
  <A>Foreign news<GO URL=“fornews.wml”/></A>
  <A>Sports<GO URL=“sports.wml”/></A>
  <A>Markets<GO URL=“markets.wml”/></A>
  <DO TYPE=“ACCEPT” LABEL=“CNN Home”>
    <GO URL=“Cnnmain.wml”/>
  </DO>
  <DO TYPE=“ACCEPT” LABEL=“CNN Help”>
    <GO URL=“helpbusi.wml”/>
  </DO>
  </CARD>
</WML>
```

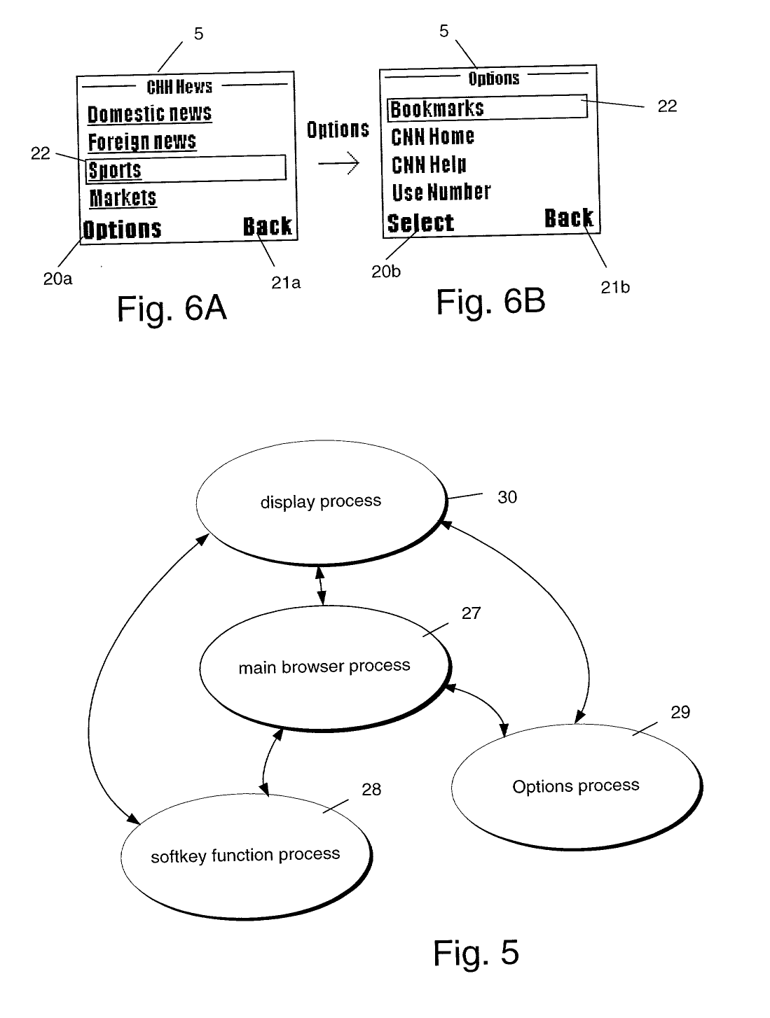

The process performed by the browser is shown schematically in FIG. 5 and comprises a main browser process 27, which parses the WML code, soft key function process 28 which responds to actuation of the soft keys 4a-c and an options process 29. The outcome of the processing is rendered to the user by a display process 30 in order to provide a display on the display screen 5.

These processes render the code of WML code snippet No. 1 to provide a display as shown in FIG. 6A on the display screen 5. The soft key function process 28 designates keys 4a and 4c as “options” and “back” 20a, 21a. When the user operates the “options” key 4a, the display shown in FIG. 6B is provided on the display screen 5, because options process 29 was selected. The options process 29 identifies anchors in the code snippet 2 that are delineated by the DO element. The anchors so identified are then rendered in the display of FIG. 6B by the options process 29. The display of FIG. 6B may also include other options that are to be displayed, produced by other means. Thus, in FIG. 6B, the anchors “CNN Home” and “CNN Help” are displayed, because they are associated with DO elements in WML code snippet 2, as shown in bold type. The display of FIG. 6B also includes “bookmarks” and “use number” which are generated separately by means of the browser process 27.

The provision of the DO element items in the options list of FIG. 6B has the advantage that individual links can be provided in the options list and so that the user can identify them without having to browse the entire deck of cards. Thus, by selecting the options display of FIG. 6B, the user can review the links irrespective of the position in the deck of cards.

An example of use of the WML access key will now be described.

WML Code Snippet No.3

```
<WML>
  <CARD NAME=“Cnnnews” TTTLE=“CNN News”>
  <A accesskey=“1”>Domestic news<GO URL=“domnews.wml”/></A>
  <A accesskey=“2”>Foreign news<GO URL=“fornews.wml”/></A>
  <A accesskey=“3”>Sports<GO URL=”sports.wml”/></A>
  <A accesskey=“4”>Markets<GO URL=“markets.wml”/></A>
  <DO TYPE=“ACCEPT” LABEL=“CNN Home”>
    <GO URL=“Cnnmain.wml”/>
  </DO>
  <DO TYPE=“ACCEPT” LABEL=“CNN Help”>
    <GO URL=“helpbusi.wml”/>
  </DO>
  </CARD>
</WML>
```

As previously explained, the accesskey attribute allows individual keys of the keypad to be assigned to particular links, to provide a shortcut. Thus, in the described example, the keys 1, 2, 3, and 4 of keypad 3 are assigned individual accesskey functions. The code snippet 3 is processed by the browser in a similar manner to that shown in FIG. 4 and the rendered displays are the same as shown in FIG. 6A and 6B.

XTML

It has recently been proposed to develop XHTML browsers for use with mobile devices such as mobile telephone handsets and PDAs. XHTML is an extension of HTML 4, which in turn is an SGML (standard generalised markup language) conforming to international standard ISO 8879 and is widely regarded as a standard publishing language for the World Wide Web. XHTML has been designed with alternate ways of accessing the Internet in mind and the XHTML family is designed with user agent interoperability in mind. However, a disadvantage of XHTML is that it does not include a DO element with functionality as described hereinbefore in relation to WML. This has the disadvantage that if a long text document is provided in XHTML, the user needs to browse through the entire document to determine the available links. There is no display that corresponds to the display of FIG. 6B, described with reference to WML. The invention seeks to overcome this problem.

XHTML does however include the accesskey attribute although, as shown above, this does not provide an options list in WML. Furthermore it does not provide an options list in conventional HTML. The accesskey functionality may be invoked with a long key-press as previously described.

According to the invention, the accesskey attribute is parsed is such a way as to provide a separate list of links available in the document. An example of XHTML code for use according to the invention is set out below as XHTML code snippet No 1.

XHTML Code Snippet No.1

<HTML>

<HEAD>

<TITLE>CNN News</TITLE>

</HEAD>

<BODY>

<A href=“domnews.html”>Domestic news</A>
<A href=“fornews.html”>Foreign news</A>
<A href=“sports.html”>Sports</A>
<A href=“markets.html”>Markets</A>
<A href=“cnnmain.html” accesskey=“1”

style=“visibility: hidden”>CNN Home</A>

<A href=“helpbusi.html” accesskey=“2”

style=“visibility: hidden”>CNN Help</A>

</BODY>

</HTML>

According to the invention, the browser process 27 of FIG. 5 is configured to parse XHTML hyper media and the display process 30 renders a display corresponding to FIG. 6A and 6B. According to the invention, links that are marked with access key attributes are provided in the options display of FIG. 6B. Thus, the previously described WML functionality is provided in XTML but without the use of a DO element.

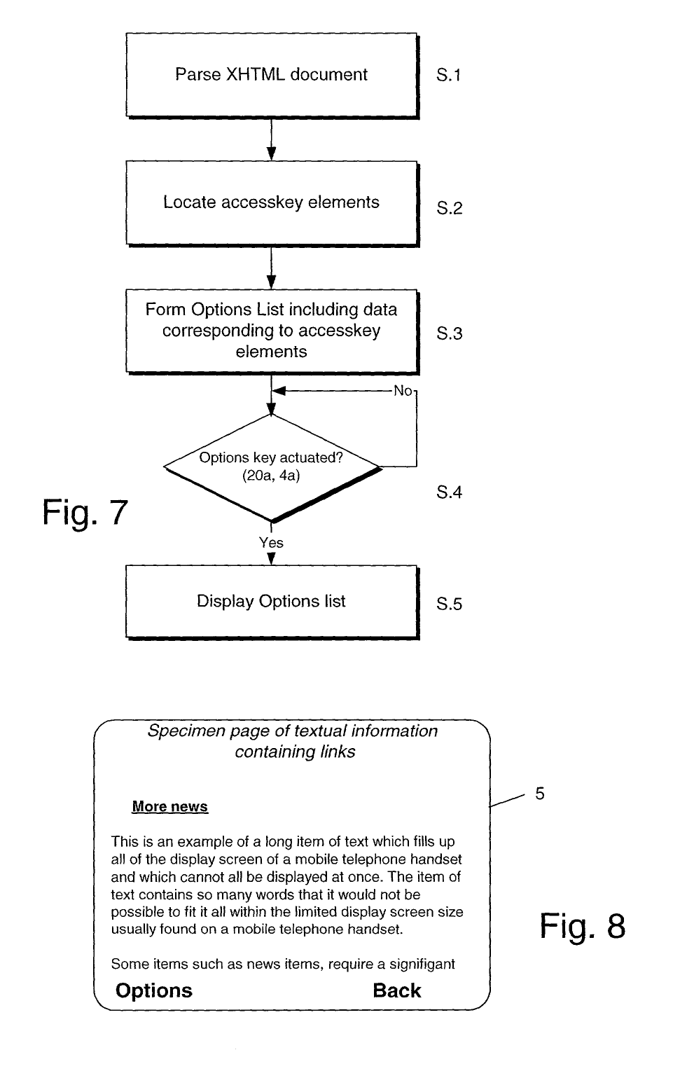

The process performed by the browser will now be described in more detail with reference to FIG. 7. At step S1, the XHTML document is parsed and at step S2, items that have been marked with an accesskey element are identified. The links associated with the elements naming an accesskey attribute are then included in an options list at step S3. As previously explained, the option process 29 shown in FIG. 5 may produce an options list that includes not only the access key elements but also other links which are provided by other processes, such as “bookmarks” and “use number”.

When the user operates the options key, namely soft key 4a with functionality 20a shown in FIG. 6A, the options list of FIG. 6B is displayed as shown at step S5.

Referring to XHTML code snippet No. 1, it will be seen that the accesskey function 1 and 2 has been assigned to the link corresponding to “CNN Home” and “CNN Help” respectively and hence these two links are displayed in the options list of FIG. 6B. It will be seen that the style has been set to “visibility: hidden” with a result that numbering associated with the accesskey functionality is suppressed. This is a usual XHTML attribute and defines the particular template that is to be used for display of the element.

Thus, the user can access these links independently of their location in the XHTML page and independently of the position of the page in the XHTML browser.

This advantage will be seen with greater clarity with reference to the following XHTML code snippet and its corresponding display.

XHTML Code Snippet No.2

<HTML>

<HEAD>

<TITLE>Specimen page of textual information

containing links</TITLE>

</HEAD>

<BODY>

<A href=“morenews.html” accesskey=“1”

style=“visibility: hidden”>more news</A>

<P> This is an example of a long item of text which

fills up all of the display screen of a mobile telephone handset
and which cannot all be displayed at once. The item of text
contains so many words that it would not be possible to fit it
all within the limited display screen size usually found on a
mobile telephone handset. </P>

<P> Some items such as news items, require a

significant number of words to describe the details of the story
that is being conveyed to the reader. </P>

<P>The item may include links to other pages, such as

a link to a page with information relating to “sports”, the
link being provided below.</P>

<A href=“sports.html” accesskey=“2”

style=“visibility: hidden”>Sports</A>

<A href=“anotherlink.html”>Another link</A>
<P>The link may be located in the text at a

particular point dependent apon the context, or at the
begining or the end. </P>

<P>The item may also include graphics and other items

such as tables. </P>

<P>Some more text is hereby provided after which some

more links are shown. When browsing the page, the user
cannot tell whether there are links in the text or whether
there are more links at the end, unless the entire page is
viewed. </P>

<P>The item may also include graphics and other items

such as tables. </P>

<P>Some more text is hereby provided after which some

more links are shown. When browsing the page, the user
cannot tell whether there are links in the text or whether
there are more links at the end, unless the entire page is
viewed. .</P>

<A href=“homepage.html” accesskey=“3”

style=“visibility: hidden”>homepage</A>

<A href=“markets.html” accesskey=“4” style=“visibility:

hidden”>markets</A>

</BODY>

</HTML>

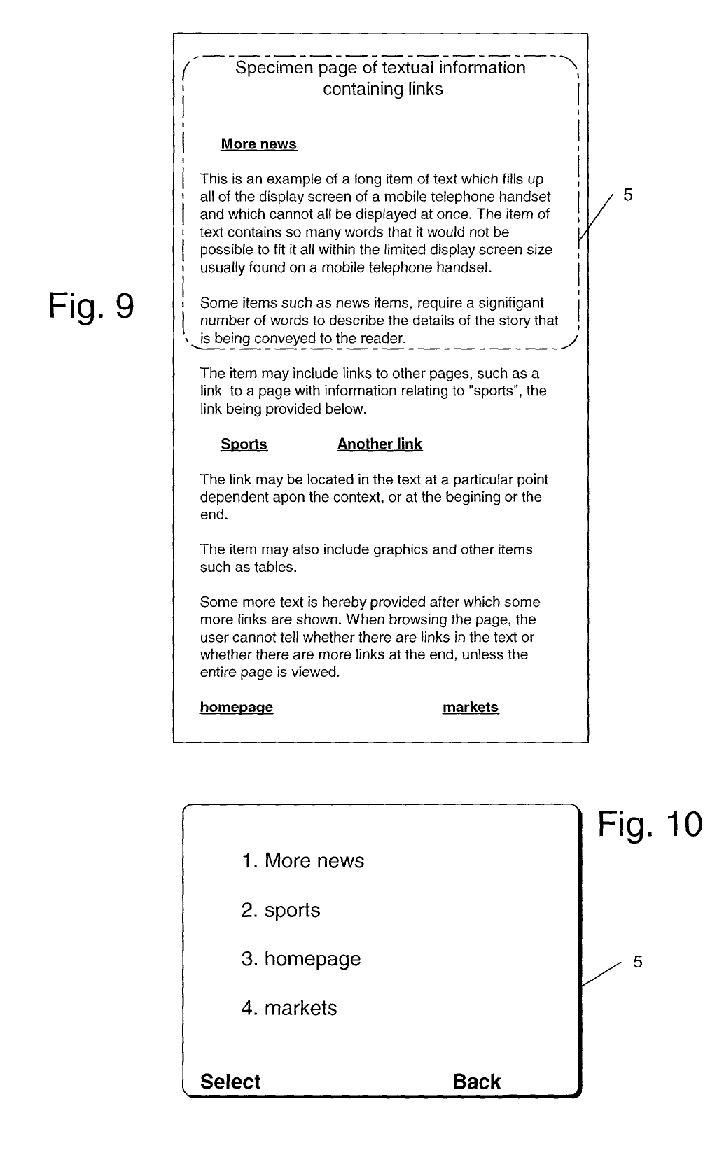

The display corresponding to the code is shown in FIGS. 8, 9 and 10. The XHTML code is parsed and processed as shown in FIG. 7 and the initial display provided on display screen 5 is shown in FIG. 8. FIG. 9 illustrates schematically that the entire HTML document cannot be displayed in the relatively small area of the screen 5 but that the document can be scrolled using the soft key 4c so that all of the XTML document can be made available for display.

It will be seen that in the display of FIG. 8, only one of the available links is initially visible to the user, namely “More News”. However, from the display of FIG. 9, it will be seen that there are four further links which are available to the user when the document is scrolled. The links “Sports” “Homepage” and “Markets” are each provided with an individual accesskey code. As a result, when the options key 4a, 20a is actuated (Step S4 of FIG. 7) the links that have been marked with accesskey elements are displayed in a separate options list as shown in FIG. 2. Thus, the user is provided with a convenient list of all the links with associated access keys irrespective of the position of the document in the browser, thus overcoming the need to scroll through the entire document to identify all of the links.

It will be noted that not all of the links need be included in the options list of FIG. 10. The “another link” shown in FIG. 9 is not marked with an accesskey function in the XHTML code and as a result is not included in the display of FIG. 10. This is under the control of the programmer.

Many modifications and variations of the invention falling within the spirit and scope of the claims are possible. For example, because the accesskey functionality is also available in WML and SGML, the invention is not restricted to XHTML but can be used with other mark up languages.

1. A method of accessing functionalities in hypermedia to be parsed and rendered by a user agent, the hypermedia including at least one element that has a predetermined attribute whereby a dynamically assignable keyboard shortcut for the user agent actuates a predetermined functionality associated with the element, the method comprising:
parsing the hypermedia
collating data corresponding to those elements in the hypermedia that support said predetermined attribute, and
rendering a display of the collated data.

2. A method according to claim 1 wherein the predetermined attribute comprises accesskey operability for assigning a particular control key for the user agent to the element.

3. A method according to claim 2 including rendering the hypermedia, and operating a control of the user agent to render the collated data instead of the hypermedia.

4. A method according to claim 4 including making a selection from the collated data whereby to select the functionality.

5. A method according to claim 1 wherein the parsing and collating is performed by a browser.

6. A method according to claim 1 wherein the hypermedia comprises an XHTML document.

7. A browser for hypermedia that includes at least one element that has a predetermined attribute whereby a dynamically assignable keyboard shortcut for the user agent actuates a predetermined functionality associated with the element, the browser including software to provide:
a parsing process to parse the hypermedia
a process to identify data corresponding to those elements in the hypermedia that support said predetermined attribute, and
a process to render a display of the data.

8. A browser according to claim 7 for use with XHTML.

9. A mobile device including a browser as claimed in claim 7.

10. A browser according to claim 7 wherein the predetermined attribute is an accesskey function.

11. A device for rendering hypermedia received from a remote server, the device including a processor for the hypermedia and a user interface including a display device and a keyboard with a plurality of keys operable in a first mode to enter associated alphanumeric data, and operable in a second mode to actuate respective keyboard shortcuts dynamically assigned thereto by elements in the hypermedia,
the processor and the display device being operable in a first display configuration to display the hypermedia,
the processor being operable to identify elements that define predetermined keyboard shortcuts in the hypermedia, and form an options list containing data associated with the identified elements, and
the processor and the display device being operable in a second display configuration to display the options list.

12. A device according to claim 11 wherein the data associated with the identified elements comprise links to other hypermedia locations, and the keyboard is operable in the second display configuration to select and actuate one of the links.

13. A device according to claim 11 wherein the keyboard is operable to switch between the first display configuration in which the hypermedia is displayed and the second configuration in which the options list is displayed.

14. A device according to claim 11 wherein the display device is configured to scroll the displayed hypermedia in said first display configuration whereby the display can be scrolled through different scrolling positions, and the options list display for the second configuration is selectable independently of the scrolling position of the first display configuration.

15. A device according to claim 14 including a scrolling device to scroll the display of hypermedia in the first configuration.

16. A device according to claim 13 wherein the keys of the keyboard are operable with a relatively short key-press in the first mode and a relatively long key-press in the second mode.

17. A device according to claim 11 wherein the elements have an accesskey keyboard shortcut function.

18. A device according to claim 17 wherein numbering associated with the accesskey keyboard shortcut function is hidden in the display of hypermedia in the first display configuration.
